(19) United States
(12) Patent Application Publication
(10) Pub. No.: US 2007/0183673 A1
(43) Pub. Date: Aug. 9, 2007

(54) Video processing method and corresponding encoding device

(75) Inventor: Stephan Oliver Mietens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,360

(22) PCT Filed: Mar. 22, 2005
(86) PCT No.: PCT/IB05/50973

§ 371 Date: Sep. 26, 2006

(30) Foreign Application Priority Data
Mar. 31, 2004 (EP) 04300174.2

(51) Int. Cl. G06K 9/36

(52) U.S. Cl. 382/236; 382/239

(57) ABSTRACT

The invention relates to a video processing method provided for processing an input image sequence consisting of successive frames and comprising for each successive frame the steps of (a) preprocessing each successive current frame by means of a first sub-step of computing for each frame a so-called content change strength (CCS) and a second sub-step of defining from the successive frames and said CCS the structure of the successive frames to be processed, and (b) processing said preprocessed frames. The frames are possibly, or preferably, subdivided into sub-structures such as blocks, segments or objects of any kind of shape. This method may be applied to the implementation of a video encoding method, for instance in video content analysis systems.

### FIELD OF THE INVENTION

The present invention relates to a video processing method provided for processing an input image sequence consisting of successive frames, said processing method comprising for each successive frame the steps of:
a) preprocessing each successive current frame by means of the sub-steps of:
   computing for each frame a so-called content-change strength (CCS);
   defining from the successive frames and the computed content-change strength the structure of the successive frames to be processed;
b) processing said pre-processed frames.
   Said method may be used for instance in computer vision and video content analysis systems. In these applications, the information generated by such systems when implementing said processing method may be either stored, for example in applications involving the use of the MPEG-7 standard, or directly used, for example in applications such as ambient light controlling, processing-resource allocation in scalable systems, wake-up trigger in security systems, etc.

### BACKGROUND OF THE INVENTION

In video compression, low bit rates for the transmission of a coded video sequence may be obtained by (among others) a reduction of the temporal redundancy between successive pictures. Such a reduction is based on motion estimation (ME) and motion compensation (MC) techniques. Performing ME and MC for the current frame of the video sequence however requires reference frames (also called anchor frames). Taking MPEG-2 as an example, different frames types, namely I-, P- and B-frames, have been defined, for which said ME and MC techniques are performed differently: I-frame (or intra frames) are coded independently, by themselves, without any reference to a past or a future frame (in fact, it means that, in that case, no ME and MC is performed), while P-frames (or forward predicted pictures) are encoded each one relatively to a past frame (i.e. with motion compensation from a previous reference frame) and B-frames (or bidirectional predicted frames) are encoded relatively to two reference frames (a past frame and a future frame). Both I- and P-frames can be used as reference frames.

In order to obtain good frame predictions, these reference frames need to be of high quality, i.e. many bits have to be spent to code them, whereas non-reference frames can be of lower quality (for this reason, a higher number of non-reference frames, B-frames in the case of MPEG-2, generally allows to use lower bit rates). In order to indicate which input frame is processed as an I-frame, a P-frame or a B-frame, a structure based on groups of pictures (GOPs) is defined in MPEG-2. More precisely, a GOP uses two parameters N and M, where N is the temporal distance between two I-frames and M is the temporal distance between reference frames (I- and P-frames). For example, an (N,M)-GOP with N=12 and M=4 is commonly used, defining an “I B B B P B B B P B B B” structure, which is then repeated.

Succeeding frames generally have a higher temporal correlation than frames having a larger temporal distance between them. Therefore shorter temporal distances between the reference frame and the currently predicted frame on the one hand lead to higher prediction quality, but on the other hand imply that less non-reference frames can be used. Both a higher prediction quality and a higher number of non-reference frames generally result in lower bit rates, but they work against each other since the frame prediction quality results from shorter temporal distances only.

However, said quality also depends on the usefulness of the reference frames to actually serve as references. For example, it is obvious that, with a reference frame located just before a scene change, the prediction of a frame located just after the scene change is not possible with respect to said reference frame, although they may have a frame distance of only 1. One the other hand, in scenes with a steady or almost steady content (like video conferencing or news), even a frame distance of more than 100 can still result in high quality prediction.

From the above-mentioned examples, it appears that a fixed GOP structure like the commonly used (12, 4)-GOP may be inefficient for coding a video sequence, because reference frames are introduced too frequently, in case of a steady content, or at a unsuitable position, if they are located just before a scene change. Scene-change detection is a known technique that can be exploited to introduce an I-frame at a position where a good prediction of the frame (if no I-frame is located at this place) is not possible due to a scene change. However, sequences do not profit from such techniques if the frame content is almost completely different after some frames having high motion, with however no scene change at all (for instance, in a sequence where a tennis player is continuously followed within a single scene).

A previous European patent application, already filed by the applicant on Oct. 14, 2003, with the filing number 03300155.3 (PHFR030124) has then described a method for finding better reference frames. The principle of said previous solution is to measure the strength (or level) of content change on the basis of some simple rules as listed below and illustrated in FIG. 1 (where the horizontal axis corresponds to the number of the concerned frame and the vertical axis to the level of the strength of content change): the measured strength of content change is quantized to levels (generally, a small number of levels is sufficient, for instance five, although the number of levels cannot be a limitation), and I-frames are inserted at the beginning of a sequence of frames having content-change strength (CCS) of level 0, while P-frames are inserted before a level increase of CCS occurs, or after a level decrease of CCS has occurred. The measure may be for instance a simple block classification that detects horizontal and vertical edges, or other types of measures based on luminance, motion vectors, etc.

An example of implementation of this previous method in the MPEG encoding case is shown in FIG. 2. The illustrated encoder comprises a coding branch 101 and a prediction branch 102. The signals to be coded, received by the branch 101, are transformed into coefficients in a DCT and quantization module 11, the quantized coefficients being then coded in a coding module 13, together with motion vectors MV. The prediction branch 102, which receives as input signals the signals available at the output of the DCT and quantization module 11, comprises in series an inverse quantization and inverse DCT module 21, an adder 23, a frame memory 24, a motion compensation (MC) circuit 25 and a subtracter 26. The MC circuit 25 also receives motion vectors generated by a motion estimation (ME) circuit 27 (many types of motion estimators may be used) from the input reordered frames (defined as explained below) and the output of the frame memory 24, and these motion vectors MV are also sent towards the coding module 13, the output of which (“MPEG output”) is stored or transmitted in the form of a multiplexed bitstream.

The video input of the encoder (successive frames Xn) is preprocessed in a preprocessing branch 103. First a GOP structure defining circuit 31 is provided for defining from the successive frames the structure of the GOPs. Frame memories 32a, 32b, . . . are then provided for reordering the sequence of I, P, B frames available at the output of the circuit 31 (the reference frames must be coded and transmitted before the non-reference frames depending on said reference frames). These reordered frames are sent on the positive input of the subtracter 26 (the negative input of which receives, as described above, the output predicted frames available at the output of the MC circuit 25, these output predicted frames being also sent back to a second input of the adder 23). The output of the subtracter 26 delivers frame differences that are the signals to be coded processed by the coding branch 101. For the definition of the GOP structure, a CCS computation circuit 33, the output of which is sent towards the circuit 31, is finally provided. The measure of CCS is obtained as indicated above.

### SUMMARY OF THE INVENTION

It is then an object of the invention to propose a processing method based on said CCS indication, but leading to a new structure, for different applications.

To this end, the invention relates to a method as described in the introductory paragraph of the invention and which is moreover characterized in that said CCS indication is re-used in a video content analysis step providing an additional input for a detection of any feature of said content.

When said method is carried out, each frame may be itself sub-divided into sub-structures such as blocks, segments, or objects of any kind of shape.

Another object of the invention is to propose the application of said processing method to the implementation of a video encoding method including a content analysis step based on the principle of the invention.

To this end, the invention relates to application of the method according to claim 1 to the implementation of a video encoding method provided for encoding an input image sequence consisting of successive frames, said encoding method comprising for each successive frame the steps of:
a) preprocessing each successive current frame by means of the sub-steps of:
   computing for each frame a so-called content-change strength (CCS);
   defining from the successive frames and the computed content-change strength the structure of the successive frames to be encoded;
   storing the frames to be encoded in an order modified with respect to the order of the original sequence of frames;
b) encoding the re-ordered frames;
   wherein said CCS indication is re-used in a video content analysis step providing an additional input for a detection of any feature of said content.

The invention also relates to a device for implementing said video encoding method.

### BRIEF DESCRIPTION OF THE DRAWINGS

The present invention will now be described, by way of example, with reference to the accompanying drawings in which:

FIG. 1 illustrates rules used in the previous European patent application cited above, for defining the place of the reference frames of the video sequence to be coded;

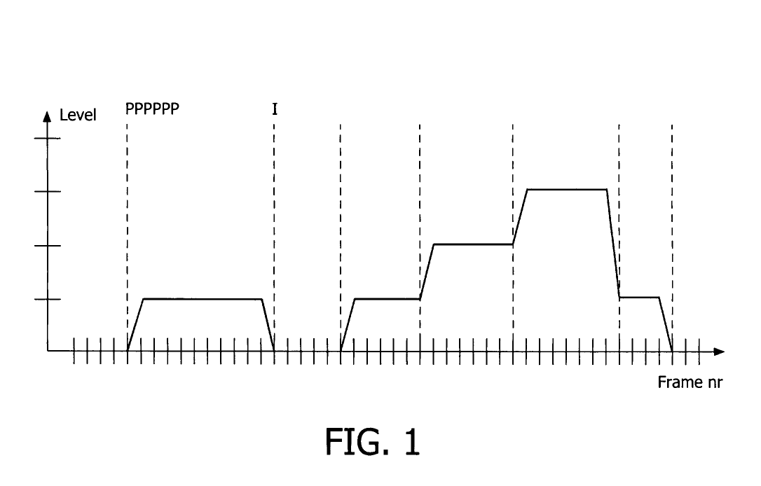

FIG. 2 illustrates an encoder allowing to carry out in the MPEG encoding case the method described in said European patent application;

FIG. 3 shows a schematic block diagram of an MPEG-7 processing chain;

FIG. 4 shows an encoder carrying out the method according to the invention.

### DETAILED DESCRIPTION OF THE INVENTION

An embodiment of the invention may be for instance the following one. It is known that the last decades have seen the development of large databases of information (composed of several types of media such as text, images, sound, etc. . . . ), and that said information has to be characterized, represented, indexed, stored, transmitted and retrieved. An appropriate example may be given for example in relation with the MPEG-7 standard, also named “Multimedia Content Description Interface” and focusing on content-based retrieval problems. This standard proposes generic ways to describe such multimedia content, i.e. it specifies a standard set of descriptors, that can be used to described these various types of multimedia information, and also ways to define the relationships of these descriptors (description schemes), in order to allow fast and efficient retrieval based on various types of features, such as text, color, texture, motion, semantic content, etc.

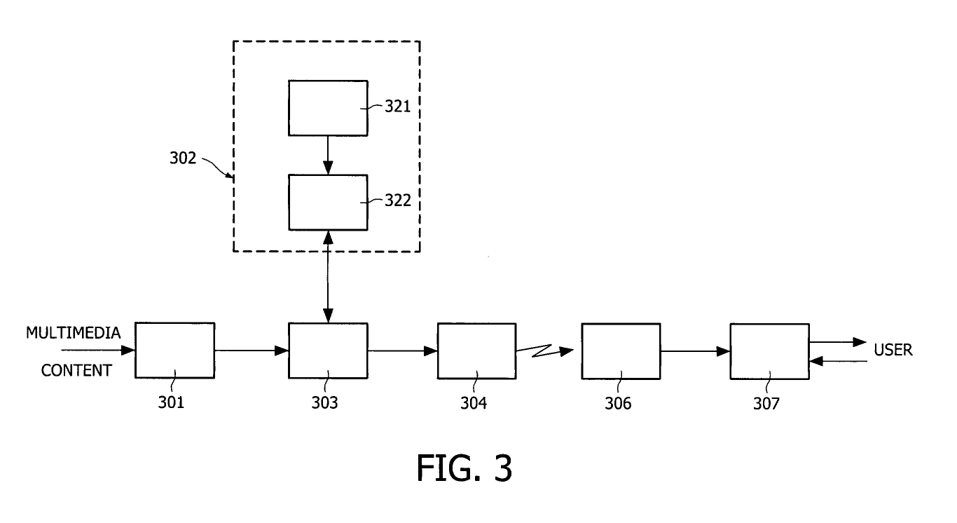

A schematic block diagram of a possible MPEG-7 processing chain, provided for processing any multimedia content, is shown in FIG. 3. This processing chain includes, at the coding side, a feature extraction sub-assembly 301 operating on said multimedia content, a normative sub-assembly 302, in which the MPEG-7 standard is applied and therefore including to this end a module 321 for yielding the MPEG-7 definition language and a module 322 for defining the MPEG-7 descriptors and description schemes, a standard description sub-assembly 303, and a coding sub-assembly 304 (FIG. 3 also gives a schematic illustration of the decoding side, including a decoding sub-assembly 306, just after a transmission operation of the coded data or a reading operation of these stored coded data, and a search engine 307, working in reply to actions controlled by a user).

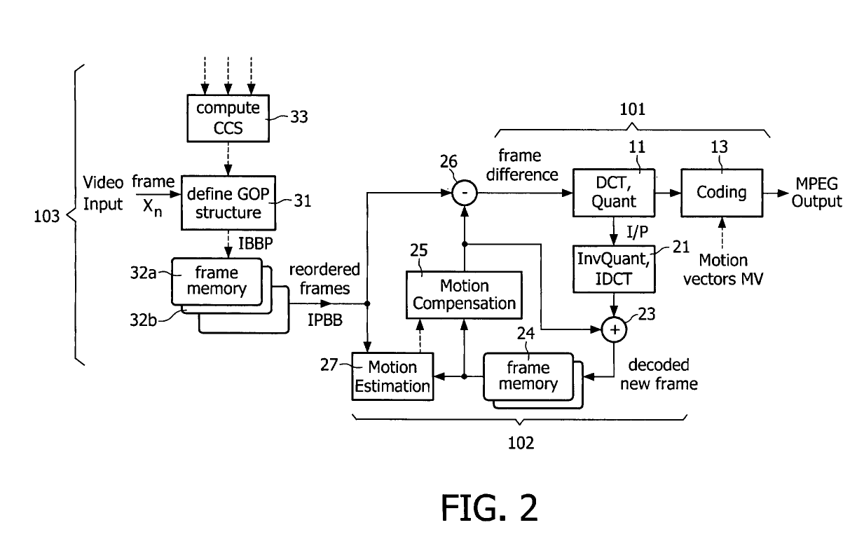

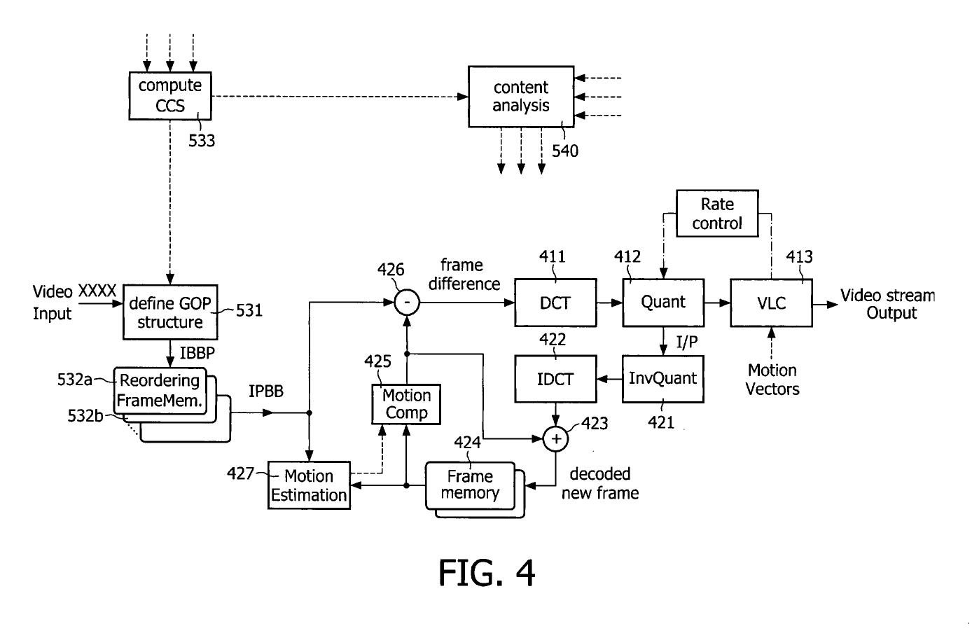

A more detailed view of the device comprising the sub-assemblies 303 and 304 is then shown in FIG. 4, in which some references are numbers similar to those indicated in FIG. 2 when they correspond to similar circuits. The coding sub-assembly 304 comprises a coding branch in which the signals to be coded, received by said branch, are transformed into coefficients in a DCT module 411, quantized in a quantization module 412, and the quantized coefficients are then coded in a coding module 413, together with motion vectors MV also received by said module 413. The coding sub-assembly 304 also comprises a prediction branch, receiving as input signals the signals available at the output of the quantization module 412, and which comprises in series an inverse quantization module 421, an inverse DCT module 422, an adder 423, a frame memory 424, an MC circuit 425 and a subtracter 426. The MC circuit 425 also receives the motion vectors generated by a ME circuit 427 from the input reordered frames (defined as explained below) and the output of the frame memory 424, and these motion vectors are also sent, as said above, towards the coding module 413, the output of which (“Video stream Output”) is stored or transmitted in the form of a multiplexed bitstream.

According to the method here proposed, the video input of the encoder (successive frames Xn) is preprocessed in a preprocessing branch, in which a GOP structure defining circuit 531 defines from the successive frames the structure of the GOPs and frame memories 532a, 532b, . . . are provided for reordering the sequence of I, P, B frames available at the output of the circuit 531 (the reference frames must be coded and transmitted before the non-reference frames depending on said reference frames). These reordered frames are sent on the positive input of the subtracter 426, the negative input of which receives, as described above, the output predicted frames available at the output of the MC circuit 425 (these predicted frames are also sent back to a second input of the adder 423) and the output of which delivers frame differences that are the signals processed by the coding branch. For the definition of the GOP structure, a CCS computation circuit 533, the output of which is sent towards the circuit 531, is finally provided, and the measure of CCS, obtained as indicated above, is sent toward a content analysis circuit 540, which is, in fact, the main circuit of the sub-assembly 303. It is connected to the normative sub-assembly 302, in order to define the normative elements that will describe the content thus analyzed.

The circuit 540 can thus provide additional input for any kind of detection, for example for detecting e.g. genre and mood of the original video, or for other types of processings, for instance for pre-filtering said video in view of a video summarization: for example, only one frame of a scene showing a non-changing content is further processed, because of the similarity of the frames in said scene.

It must be understood that the present invention is not limited to the aforementioned embodiments, and variations and modifications may be proposed without departing from the spirit and scope of the invention as defined in the appended claims. In the respect, the following closing remarks are made.

There are numerous ways of implementing functions of the method according to the invention by means of items of hardware or software, or both. The drawings are very diagrammatic and represent only one possible embodiment of the invention. If a drawing shows different functions as different blocks, it does not exclude that a single item of hardware of software carry out several functions, nor it excludes that an assembly of items of hardware are software or both carry out a function. Said hardware or software items can be implemented in several manners, such as by means of wired electronic circuits or by means of an integrated circuit that is suitable programmed in a suitable manner.

Any reference sign in the following claims should not be construed as limiting them. It will be obvious that the use of the verb “to comprise” and its conjugations does not exclude the presence of other steps or elements than those defined in any claim. The article “a” or “an” preceding an element or step does not exclude the presence of a plurality of such elements or steps.

1. A video processing method provided for processing an input image sequence consisting of successive frames, said processing method comprising for each successive frame the steps of:
a) preprocessing each successive current frame by means of the sub-steps of:
computing for each frame a so-called content-change strength (CCS);
defining from the successive frames and the computed content-change strength the structure of the successive frames to be processed;
b) processing said pre-processed frames;
wherein said CCS indication is re-used in a video content analysis step providing an additional input for a detection of any feature of said content.

2. A method according to claim 1, in which each frame is itself subdivided into sub-structures.

3. A method according to claim 2, in which said sub-structures are blocks.

4. A method according to claim 2, in which said sub-structures are objects of any kind of shape.

5. A method according to claim 2, in which said sub-structures are segments.

6. Application of the method of claim 1 to the implementation of a video encoding method provided for encoding an input image sequence consisting of successive frames, said encoding method comprising for each successive frame the steps of:
a) preprocessing each successive current frame by means of the sub-steps of:
computing for each frame a so-called content-change strength (CCS);
defining from the successive frames and the computed content-change strength the structure of the successive frames to be encoded;
storing the frames to be encoded in an order modified with respect to the order of the original sequence of frames;
b) encoding the re-ordered frames;
wherein said CCS indication is re-used in a video content analysis step providing an additional input for a detection of any feature of said content.

7. A method according to claim 6, in which each frame is itself subdivided into sub-structures.

8. A method according to claim 7, in which said sub-structures are blocks.

9. A method according to claim 7, in which said sub-structures are objects of any kind of shape.

10. A method according to claim 7, in which said sub-structures are segments.

11. A video encoding device provided for encoding an input image sequence consisting of successive groups of frames in which each frame is itself subdivided into blocks, said encoding device comprising the following means, applied to each successive frame:
a) preprocessing means, applied to each successive current frame;
b) estimating means, provided for estimating a motion vector for each block;
c) generating means, provided for generating a predicted frame on the basis of said motion vectors respectively associated to the blocks of the current frame;
d) transforming and quantizing means, provided for applying to a difference signal between the current frame and the last predicted frame a transformation producing a plurality of coefficients and followed by a quantization of said coefficients;
e) coding means, provided for encoding said quantized coefficients;
said preprocessing means comprising itself the following means:
computing means, provided for computing for each frame a so-called content-change strength (CCS);
defining means, provided for defining from the successive frames and the computed content-change strength the structure of the successive groups of frames to be encoded;
storing means, provided for storing the frames to be encoded in an order modified with respect to the order of the original sequence of frames;
wherein said CCS indication is re-used in a video content analysis step providing an additional input for a detection of any feature of said content.
